(19) United States
(12) Patent Application Publication
(10) Pub. No.: US 2018/0345729 A1
(43) Pub. Date: Dec. 6, 2018

(54) Pneumatic Tire

(71) Applicants: The Yokohama Rubber Co., LTD., Minato-ku, Tokyo (JP); Kumho Tire Co., Inc., Gwangsan-gu, Gwangju (KR)

(72) Inventors: Hiroshi HATA, Hiratsuka-shi, Kanagawa (JP); Jun MATSUDA, Hiratsuka-shi, Kanagawa (JP); Kee Woon KIM, Gwangsan-gu, Gwangju (KR); Chang Jung PARK, Gwangsan-gu, Gwangju (KR)

(73) Assignees: The Yokohama Rubber Co., Ltd., Minato-ku ,Tokyo (JP); Kumho Tire Co., Inc., Gwangsan-gu ,Gwangju (KR)

(21) Appl. No.: 15/778,618

(22) PCT Filed: Nov. 25, 2015
(86) PCT No.: PCT/JP2015/083121

§ 371 Date: May 23, 2018

(51) Int. Cl. B60C 11/01; B60C 13/00

(52) U.S. Cl. CPC B60C 11/01; B60C 13/00

(57) ABSTRACT

A pneumatic tire comprises a lug groove disposed outermost in a tire lateral direction in a tread portion, the lug groove opening outward in the tire lateral direction; a projection portion disposed outward of an opening portion of the lug groove in the tire lateral direction, the projection portion extending outward in a tire radial direction past a groove bottom of the lug groove at maximum groove depth and comprising an end disposed inward of a road contact surface of the tread portion in the tire radial direction, when the pneumatic tire is mounted on a regular rim, inflated to a regular internal pressure, and loaded with 70% of a regular load; and a stopper portion projecting from a surface of the tread portion at a position outward of a ground contact edge in the tire lateral direction and inward of the projection portion in the tire lateral direction.

### TECHNICAL FIELD

The present technology relates to a pneumatic tire that reduces external noise.

### BACKGROUND ART

Pneumatic tires designed to reduce vehicle external noise are known. For example, the pneumatic tire described in Japanese Unexamined Patent Publication No. 2012-096776 includes a lug groove that opens outward in a tire lateral direction on an outermost side of a tread portion in the tire lateral direction, and a projection portion disposed outward of the opening portion of the lug groove in the tire lateral direction. According to this pneumatic tire, by the projection portion being located outward of the opening portion of the lug groove in the tire lateral direction, when a vehicle on which the pneumatic tire is mounted travels, the sound produced by air column resonance is prevented from being released outward from the lug groove in the tire lateral direction. As a result, vehicle external noise can be reduced.

In another example, the pneumatic tire described in Japanese Unexamined Patent Publication No. 2012-006483 includes a projection portion on an outer surface of a buttress portion, the projection portion projecting outward in a tire radial direction and continuously extending in a tire circumferential direction.

As described above, Japanese Unexamined Patent Publication Nos. 2012-096776 and 2012-006483 describe a projection portion blocking sound from being released outward in the tire lateral direction. However, when the pneumatic tire rolls, the pneumatic tire deforms as it comes into contact with the ground, causing the projection portion to deform inward in the tire lateral direction. As a result, the noise shielding effect is reduced so that the vehicle external noise reduction effect may be reduced or a vehicle external noise reduction effect may not be obtained. Also, the opening portion outward of the lug groove in the tire lateral direction is blocked, and thus water resistance and hydroplaning resistance performance may be reduced.

### SUMMARY

The present technology provides a pneumatic tire that can ensure a vehicle external noise reduction effect and hydroplaning resistance performance.

A pneumatic tire according to an embodiment of the present technology includes a lug groove disposed outermost in a tire lateral direction in a tread portion, the lug groove opening outward in the tire lateral direction; a projection portion disposed outward of an opening portion of the lug groove in the tire lateral direction, the projection portion extending outward in a tire radial direction past a groove bottom of the lug groove at maximum groove depth in a meridian cross-section and including an end disposed inward of a road contact surface of the tread portion in the tire radial direction, when the pneumatic tire is mounted on a regular rim, inflated to a regular internal pressure, and loaded with 70% of a regular load; and a stopper portion projecting from a surface of the tread portion at a position outward of a ground contact edge in the tire lateral direction and inward of the projection portion in the tire lateral direction.

According to the pneumatic tire, the stopper portion supports the projection portion that deforms inward in the tire lateral direction when the pneumatic tire deforms as it comes into contact with the ground when the pneumatic tire rolls and prevents the projection portion from collapsing toward the surface of the tread portion. Thus, a vehicle exterior noise reduction effect can be ensured, and because water discharge from the lug groove is not blocked, hydroplaning resistance performance can be ensured.

In a pneumatic tire according to an embodiment of the present technology, the stopper portion is at least partially disposed in a range where the projection portion is projected inward in the tire lateral direction on the surface of the tread portion.

According to the pneumatic tire, the stopper portion can effectively support the projection portion which deforms inward in the tire lateral direction and prevent collapsing.

In a pneumatic tire according to an embodiment of the present technology, the stopper portion has a dimension in the tire lateral direction ranging from 10% to 90% of a range in the tire lateral direction where the projection portion is projected inward in the tire lateral direction on the surface of the tread portion.

When the dimension of the stopper portion in the tire lateral direction is less than 10% of the range where the projection portion is projected, the stopper portion readily deforms. As a result, the projection portion which deforms inward in the tire lateral direction becomes difficult to support, and the effect of ensuring a vehicle exterior noise reduction effect and hydroplaning resistance performance is decreased. When the dimension of the stopper portion in the tire lateral direction is greater than 90% of the range where the projection portion is projected, the stopper portion becomes a wall that blocks the lug groove on both sides in the tire circumferential direction. As a result, drainage properties decrease, and the effect of ensuring hydroplaning resistance performance is decreased. Thus, according to the pneumatic tire, the effect of ensuring a vehicle exterior noise reduction effect and hydroplaning resistance performance can be significantly obtained.

In a pneumatic tire according to an embodiment of the present technology, the stopper portion has a height projecting from the surface of the tread portion of 0.5 mm or greater.

When the projection height is less than 0.5 mm, the projection portion which deforms inward in the tire lateral direction almost comes into contact with the surface of the tread portion. As a result, the effect of ensuring a vehicle exterior noise reduction effect and hydroplaning resistance performance is likely to decrease. Thus, according to the pneumatic tire, the effect of ensuring a vehicle exterior noise reduction effect and hydroplaning resistance performance can be significantly obtained.

In a pneumatic tire according to an embodiment of the present technology, the stopper portion has a total dimension in a tire circumferential direction of from 10% to 100% of a total dimension in the tire circumferential direction between the lug grooves in the surface of the tread portion.

When the total dimension of the stopper portions in the tire circumferential direction is less than 10% of the total dimension between the lug grooves in the tire circumferential direction, the projection portion which deforms inward in the tire lateral direction becomes difficult to support via the stopper portion. As a result, the effect of ensuring a vehicle exterior noise reduction effect and hydroplaning resistance performance is likely to decrease. Thus, according to the pneumatic tire, the effect of ensuring a vehicle exterior noise reduction effect and hydroplaning resistance performance can be significantly obtained.

In a pneumatic tire according to an embodiment of the present technology, the projection portion has a distance in the tire radial direction from the road contact surface of the tread portion to the end of 0.5 mm or greater, when the pneumatic tire is mounted on a regular rim, inflated to a regular internal pressure, and loaded with 70% of a regular load.

In a case where the distance in the tire radial direction between the road contact surface of the tread portion and the end being less than 0.5 mm, when the pneumatic tire deforms when the vehicle travels, the frequency of the projection portion coming into contact with the road surface and the like is likely to increase, increasing instances of the projection portion deforming. Thus, according to the pneumatic tire, by the distance in the tire radial direction between the road contact surface of the tread portion and the end being 0.5 mm to greater, the instances of the projection portion deforming are reduced. This allows a vehicle exterior noise reduction effect to be ensured.

In a pneumatic tire according to an embodiment of the present technology, the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

When the angle formed by the center straight line and the tire radial direction line is greater than 15° inward in the tire lateral direction, the projection portion is susceptible to coming into contact with the tire itself, which may cause wear and chipping in the portion where contact occurs. When the angle formed by the center straight line and the tire radial direction line is greater than 45° outward in the tire lateral direction, the projection portion is disposed away from the lug groove, and a noise shielding effect is difficult to obtain. Thus, according to the pneumatic tire, by the angle formed by the center straight line and the tire radial direction line ranging from 15° inward in the tire lateral direction to 45° outward in the tire lateral direction (from −15° to +45°, where inward in the tire lateral direction is minus and outward in the tire lateral direction is plus), a noise shielding effect from the projection portion can be significantly obtained.

In a pneumatic tire according to an embodiment of the present technology, a vehicle inner/outer side orientation when the pneumatic tire is mounted on a vehicle is designated, and the projection portion is at least formed on a vehicle outer side.

According to the pneumatic tire, vehicle external noise is released on the vehicle outer side. Thus, by forming the projection portion on at least the vehicle outer side, noise shielding can be effectively provided, and vehicle external noise can be reduced.

A pneumatic tire according to an embodiment of the present technology can ensure a vehicle exterior noise reduction effect and hydroplaning resistance performance.

### BRIEF DESCRIPTION OF DRAWINGS

FIG. 1 is a meridian cross-sectional view of a pneumatic tire according to an embodiment of the present technology.

FIG. 2 is a meridian cross-sectional view of a pneumatic tire according to an embodiment of the present technology.

FIG. 3 is an enlarged view of a main portion of the pneumatic tire illustrated in FIGS. 1 and 2.

FIG. 4 is an enlarged view of a main portion of the pneumatic tire illustrated in FIGS. 1 and 2.

FIG. 5 is an enlarged meridian cross-section view of a stopper portion.

FIG. 6 is an enlarged meridian cross-section view of a stopper portion.

FIG. 7 is an enlarged meridian cross-section view of a stopper portion.

FIG. 8 is an enlarged meridian cross-section view of a stopper portion.

FIG. 9 is an enlarged meridian cross-section view of a stopper portion.

FIG. 10 is a plan view of projection portions and stopper portions.

FIG. 11 is a plan view of projection portions and stopper portions.

FIG. 12 is a plan view of projection portions and stopper portions.

FIG. 13 is a plan view of projection portions and stopper portions.

FIG. 14 is an enlarged cross-sectional view of a main portion of another example of a pneumatic tire according to an embodiment of the present technology.

FIG. 15 is a partial perspective view of another example of the pneumatic tire illustrated in FIG. 14.

FIG. 16 is a table showing the results of performance tests of pneumatic tires according to examples of the present technology.

FIG. 17 is a table showing the results of performance tests of pneumatic tires according to examples of the present technology.

### DETAILED DESCRIPTION

Embodiments of the present technology are described in detail below with reference to the drawings. However, the present technology is not limited by the embodiments. Constituents of the embodiments include elements that can be easily replaced by those skilled in the art and elements substantially the same as the constituents of the embodiments. Furthermore, the modified examples described in the embodiments can be combined as desired within the scope apparent to those skilled in the art.

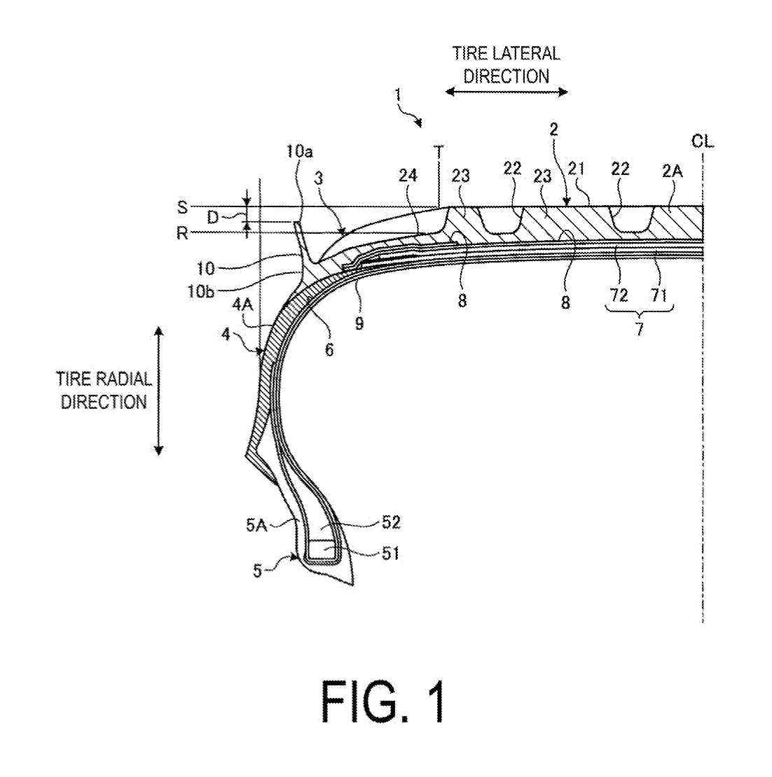

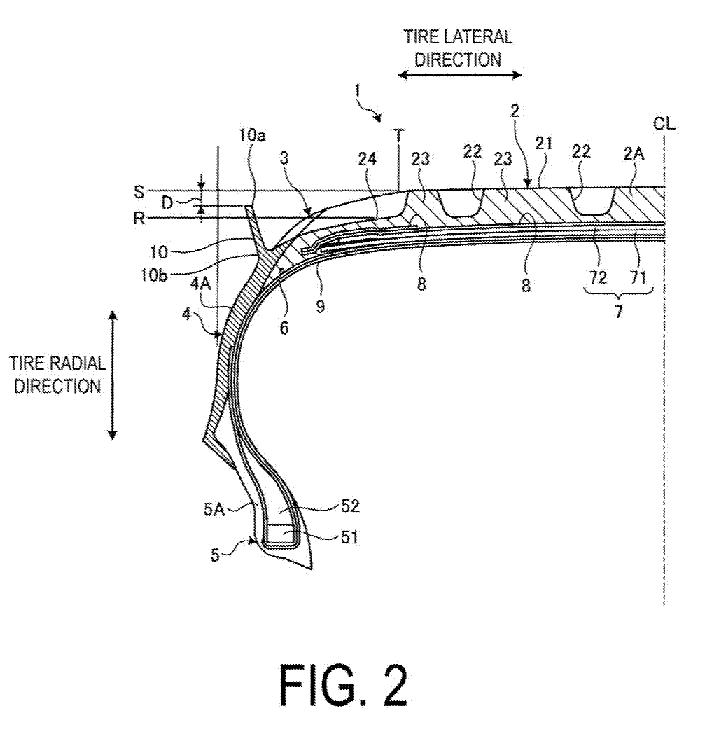

FIGS. 1 and 2 are meridian cross-sectional views of a pneumatic tire according to the present embodiment.

Herein, “tire radial direction” refers to the direction orthogonal to the rotation axis (not illustrated) of a pneumatic tire 1. “Inward in the tire radial direction” refers to the direction toward the rotation axis in the tire radial direction. “Outward in the tire radial direction” refers to the direction away from the rotation axis in the tire radial direction. “Tire circumferential direction” refers to the circumferential direction with the rotation axis as the center axis. Additionally, “tire lateral direction” refers to the direction parallel with the rotation axis. “Inward in the tire lateral direction” refers to the direction toward a tire equatorial plane CL (tire equator line) in the tire lateral direction. “Outward in the tire lateral direction” refers to the direction away from the tire equatorial plane CL in the tire lateral direction. “Tire equatorial plane CL” refers to the plane orthogonal to the rotation axis of the pneumatic tire 1 that passes through the center of the tire width of the pneumatic tire 1. “Tire width” is the width in the tire lateral direction between components located outward in the tire lateral direction, or in other words, the distance between the components that are the most distant from the tire equatorial plane CL in the tire lateral direction. “Tire equator line” refers to the line along the tire circumferential direction of the pneumatic tire 1 that lies on the tire equatorial plane CL. In the present embodiment, the tire equator line and the tire equatorial plane are denoted by the same reference sign CL. In addition, the pneumatic tire 1 described below has a configuration which is essentially symmetrical about the tire equatorial plane CL. Thus, for the sake of description, the pneumatic tire 1 is illustrated in a meridian cross-sectional view (FIGS. 1 and 2) and described in reference to the configuration on only one side (the left side in FIGS. 1 and 2) of the tire equatorial plane CL. A description of the other side (right side in FIGS. 1 and 2) is omitted.

As illustrated in FIGS. 1 and 2, the pneumatic tire 1 of the present embodiment includes a tread portion 2, shoulder portions 3 on opposite sides of the tread portion 2, and sidewall portions 4 and bead portions 5 continuing in that order from the shoulder portions 3. The pneumatic tire 1 also includes a carcass layer 6, a belt layer 7, a belt reinforcing layer 8, and an innerliner layer 9.

The tread portion 2 is made of tread rubber 2A, is exposed on the outermost side of the pneumatic tire 1 in the tire radial direction, and the surface thereof constitutes the contour of the pneumatic tire 1. A tread surface 21 is formed on the outer circumferential surface of the tread portion 2, in other words, on a road contact surface S that comes into contact with the road surface when running. The tread surface 21 is provided with a plurality (four in the present embodiment) of main grooves 22 that are straight main grooves extending in the tire circumferential direction parallel with the tire equator line CL. Moreover, a plurality of rib-like land portions 23 that extend in the tire circumferential direction are formed in the tread surface 21 by the plurality of main grooves 22. Note that the main grooves 22 may extend in the tire circumferential direction in a bending or curving manner. Additionally, lug grooves 24 that extend in a direction that intersects the main grooves 22 are provided in the land portions 23 of the tread surface 21. In the present embodiment, the lug grooves 24 show in the outermost land portions 23 in the tire lateral direction. The lug grooves 24 may meet the main grooves 22. Alternatively, the lug grooves 24 may have at least one end that does not meet the main grooves 22 and terminates within a land portion 23. In an embodiment in which both ends of the lug grooves 24 meet the main grooves 22, the land portions 23 are formed into a plurality of block-like land portions divided in the tire circumferential direction. Note that the lug grooves 24 may extend inclined with respect to the tire circumferential direction in a bending or curving manner.

The shoulder portions 3 are portions of the tread portion 2 located outward in the tire lateral direction on both sides. In other words, the shoulder portions 3 are made of the tread rubber 2A. Additionally, the sidewall portions 4 are exposed on the outermost sides of the pneumatic tire 1 in the tire lateral direction. The sidewall portions 4 are each made of a side rubber 4A. As illustrated in FIG. 1, an outer end portion of the side rubber 4A in the tire radial direction is disposed inward of an end portion of the tread rubber 2A in the tire radial direction. An inner end portion of the side rubber 4A in the tire radial direction is disposed outward of an end portion of a rim cushion rubber 5A described below in the tire lateral direction. Additionally, as illustrated in FIG. 2, the outer end portion of the side rubber 4A in the tire radial direction may b e disposed outward of the end portion of the tread rubber 2A in the tire radial direction. The bead portions 5 each include a bead core 51 and a bead filler 52. The bead core 51 is formed by winding a bead wire, which is a steel wire, into an annular shape. The bead filler 52 is a rubber material that is disposed in the space formed by an end of the carcass layer 6 in the tire lateral direction folded back at the position of the bead core 51. The bead portions 5 each include an outwardly exposed rim cushion rubber 5A that comes into contact with the rim (not illustrated). The rim cushion rubber 5A extends from the tire inner side of the bead portion 5 around the lower end portion thereof to a position (sidewall portion 4) covering the bead filler 52 on the tire outer side.

The end portions of the carcass layer 6 in the tire lateral direction are folded back around the pair of bead cores 51 from inward to outward in the tire lateral direction, and the carcass layer 6 is stretched in a toroidal shape in the tire circumferential direction to form the framework of the tire. Note that the carcass layer 6 has a configuration that is mainly continuous in a radial direction, but may include a divided portion on the inner side of the tread portion 2 in the tire radial direction. The carcass layer 6 is constituted by a plurality of coating-rubber-covered carcass cords (not illustrated) disposed in alignment at an angle with respect to the tire circumferential direction that conforms with the tire meridian direction. The carcass layer 6 is provided with at least one layer.

The belt layer 7 has a multilayer structure in which at least two belts 71, 72 are layered. In the tread portion 2, the belt layer 7 is disposed outward of the carcass layer 6 in the tire radial direction, i.e. on the outer circumference thereof, and covers the carcass layer 6 in the tire circumferential direction. The belts 71 and 72 each include a plurality of coating-rubber-covered cords (not illustrated) disposed in alignment at a predetermined angle with respect to the tire circumferential direction (for example, from 20 degrees to 30 degrees). Moreover, the belts 71 and 72 overlap each other and are disposed so that the direction of the cords of the respective belts intersect each other.

The belt reinforcing layer 8 may be provided for support as necessary. The belt reinforcing layer 8 is disposed outward of the belt layer 7 in the tire radial direction, i.e. on the outer circumference thereof, and covers the belt layer 7 in the tire circumferential direction. The belt reinforcing layer 8 includes a plurality of coating-rubber-covered cords (not illustrated) disposed in alignment in the tire lateral direction substantially parallel (±5 degrees) with the tire circumferential direction. The belt reinforcing layer 8 illustrated in FIGS. 1 and 2 is disposed so as to cover the entire belt layer 7 and disposed in a layered manner so as to cover end portions of the belt layer 7 in the tire lateral direction. The configuration of the belt reinforcing layer 8 is not limited to that described above. While not illustrated in the drawings, a configuration may be used in which, for example, two layers are disposed so as to cover all of the belt layer 7 or to cover only the end portions of the belt layer 7 in the tire lateral direction. Additionally, while not illustrated in the drawings, a configuration of the belt reinforcing layer 8 may be used in which, for example, one layer is disposed so as to cover all of the belt layer 7 or to cover only the end portions of the belt layer 7 in the tire lateral direction. In other words, the belt reinforcing layer 8 overlaps with at least the end portions of the belt layer 7 in the tire lateral direction. Additionally, the belt reinforcing layer 8 is constituted of a band-like strip material (having, for example, a width of 10 mm) wound in the tire circumferential direction.

The innerliner layer 9 is the tire inner surface, i.e. the inner circumferential surface of the carcass layer 6, and reaches the lower portion of the bead cores 51 of the pair of bead portions 5 at both end portions in the tire lateral direction and extends in the tire circumferential direction in a toroidal shape. The innerliner layer 9 prevents air molecules from escaping from the tire.

The pneumatic tire 1 described above is provided with a projection portion 10 on the shoulder portion 3. The projection portion 10 is provided continuously in the tire circumferential direction and is disposed outward in the tire lateral direction of the opening portion of the outermost lug groove 24 in the tire lateral direction provided on the tread portion 2. The projection portion 10 is formed projecting outward in the tire radial direction. Additionally, the projection portion 10, in a meridian cross-section, extends outward in the tire radial direction of a groove bottom R with the maximum groove depth of the outermost lug groove 24 in the tire lateral direction, and an end 10a of the projection portion 10 is disposed inward in the tire radial direction of the road contact surface S of the tread portion 2, when the pneumatic tire 1 is mounted on a regular rim, inflated to the regular internal pressure, and loaded with 70% of the regular load. Note that a portion of the lug groove 24 may run into the inner surface in the tire lateral direction of the projection portion 10.

Here, “regular rim” refers to a “standard rim” defined by the Japan Automobile Tyre Manufacturers Association Inc. (JATMA), a “Design rim” defined by the Tire and Rim Association, Inc. (TRA), or a “Measuring rim” defined by the European Tyre and Rim Technical Organisation (ETRTO). “Regular internal pressure” refers to “maximum air pressure” defined by JATMA, a maximum value given in “TIRE LOAD LIMITS AT VARIOUS COLD INFLATION PRESSURES” defined by TRA, or “INFLATION PRESSURES” defined by ETRTO. “Regular load” refers a “maximum load capacity” defined by JATMA, the maximum value given in “TIRE LOAD LIMITS AT VARIOUS COLD INFLATION PRESSURES” defined by TRA, and a “LOAD CAPACITY” defined by ETRTO.

The road contact surface S is the surface where the tread surface 21 of the pneumatic tire 1 comes into contact with the road surface (flat surface), when the pneumatic tire 1 is mounted on a regular rim, inflated to the regular internal pressure, and loaded with 70% of the regular load. Note that both ends of the road contact surface S in the tire lateral direction include ground contact edges T and are continuous in the tire circumferential direction as the tire rolls.

As illustrated in FIGS. 1 and 2, the projection portion 10 is integrally formed with the tread rubber 2A of the tread portion 2 or the side rubber 4A of the sidewall portion 4 described above. In the pneumatic tire 1 illustrated in FIG. 1, an outer end portion of the side rubber 4A in the tire radial direction is disposed inward of an end portion of the tread rubber 2A in the tire radial direction, and the projection portion 10 is disposed together with the outer end portion of the tread rubber 2A in the tire lateral direction. In the pneumatic tire 1 illustrated in FIG. 2, an outer end portion of the side rubber 4A in the tire radial direction is disposed outward of an end portion of the tread rubber 2A in the tire radial direction, and the projection portion 10 is disposed together with the outer end portion of the side rubber 4A in the tire radial direction.

According to this pneumatic tire 1, by the projection portion 10 being located outward of the opening portion of the lug groove 24 in the tire lateral direction, when a vehicle on which the pneumatic tire 1 is mounted travels, the sound produced by air column resonance is shielded and prevented from being released outward from the lug groove 24 in the tire lateral direction. As a result, vehicle external noise can be reduced.

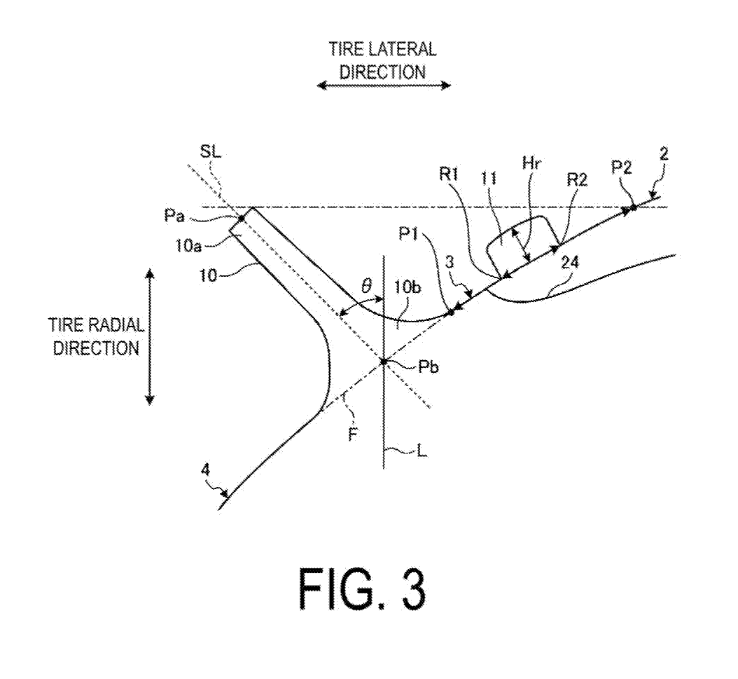

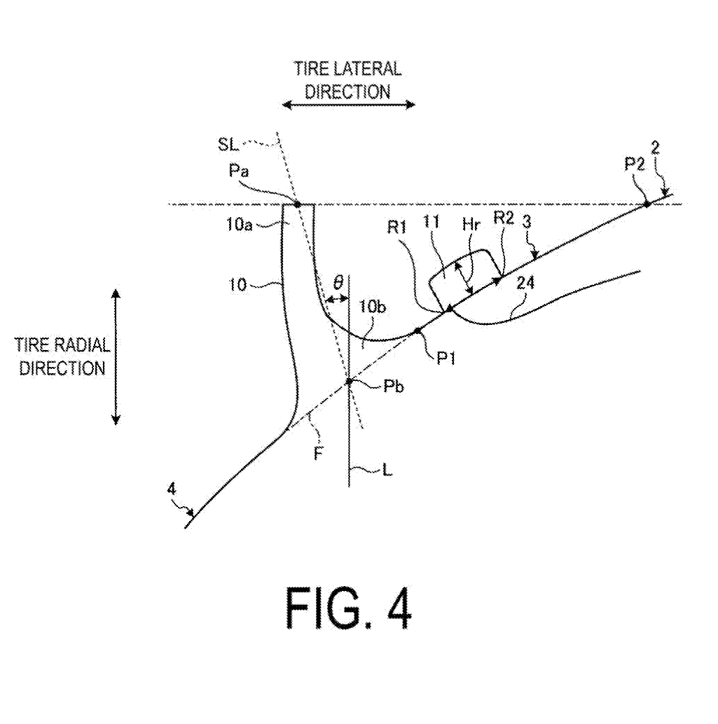

FIGS. 3 and 4 are enlarged views of a main portion of the pneumatic tire illustrated in FIGS. 1 and 2, with the projection portion 10 enlarged. As illustrated in FIGS. 3 and 4, the pneumatic tire 1 of the present embodiment includes a stopper portion 11.

The stopper portion 11 is formed projecting from the surface of the tread portion 2 (surface of the land portion 23) inward of the projection portion 10 in the tire lateral direction and outward in the tire lateral direction of the ground contact edge T illustrated in FIGS. 1 and 2.

According to the pneumatic tire 1, the stopper portion 11 comes into contact with the ground when the pneumatic tire rolls, and thus supports the projection portion 10 that deforms inward in the tire lateral direction when the pneumatic tire deforms, and prevents the projection portion 10 from collapsing toward the surface of the tread portion 2. Thus, a vehicle exterior noise reduction effect can be ensured, and because water discharge from the lug groove 24 is not blocked, hydroplaning resistance performance can be ensured.

As illustrated in FIGS. 3 and 4, in the pneumatic tire 1 of the present embodiment, the stopper portion 11 is at least partially disposed in a range Wp between points P1-P2 where the projection portion 10 is projected inward in the tire lateral direction on the surface of the tread portion 2.

The P1 is a position on an imaginary profile F of the shoulder portion 3 between the tread portion 2 and the sidewall portion 4 where a base end 10b of the projection portion 10 builds up on the inner side in the tire lateral direction. The P2 is a portion on the surface of the tread portion 2 where the end 10a of the projection portion 10 is projected to inward in the tire lateral direction. The range between P1-P2 on the surface of the tread portion 2 on the imaginary profile F is the range Wp on the surface of the tread portion 2 in which the projection portion 10 is projected inward in the tire lateral direction.

According to the pneumatic tire 1, the stopper portion 11 can effectively support the projection portion 10 which deforms inward in the tire lateral direction and prevent collapsing.

Additionally, in the pneumatic tire 1 of the present embodiment, the stopper portion 11 is formed with a dimension Wr in the tire lateral direction ranging from 10% to 90% of the range Wp in the tire lateral direction of the surface of the tread portion 2 where the projection portion 10 is projected inward in the tire lateral direction.

The dimension Wr of the stopper portion 11 in the tire lateral direction is the dimension on the imaginary profile F between positions R1-R2 in the tire lateral direction where the stopper portion 11 builds up on the imaginary profile F of the shoulder portion 3 between the tread portion 2 and the sidewall portion 4.

When the dimension Wr of the stopper portion 11 in the tire lateral direction is less than 10% of the range Wp where the projection portion 10 is projected, the stopper portion 11 readily deforms. As a result, the projection portion 10 which deforms inward in the tire lateral direction becomes difficult to support, and the effect of ensuring a vehicle exterior noise reduction effect and hydroplaning resistance performance is decreased. When the dimension Wr of the stopper portion 11 in the tire lateral direction is greater than 90% of the projection range Wp of the projection portion 10, the stopper portion 11 becomes a wall that blocks the lug groove 24 on both sides in the tire circumferential direction. As a result, drainage properties decrease, and the effect of ensuring hydroplaning resistance performance is decreased. Thus, according to the pneumatic tire 1, the effect of ensuring a vehicle exterior noise reduction effect and hydroplaning resistance performance can be significantly obtained. Note that to significantly obtain the effect of ensuring a vehicle exterior noise reduction effect and hydroplaning resistance performance, the dimension Wr of the stopper portion 11 in the tire lateral direction preferably ranges from 15% to 70% of the projection range Wp of the projection portion 10, and more preferably from 25% to 40%. Additionally, a plurality of the stopper portions 11 with the dimension Wr in the tire lateral direction in the range described above in relation to the projection range Wp of the projection portion 10 may be disposed in the tire lateral direction.

Additionally, in the pneumatic tire 1 of the present embodiment, the stopper portion 11 preferably projects from the surface of the tread portion 2 with a height Hr of 0.5 mm or greater.

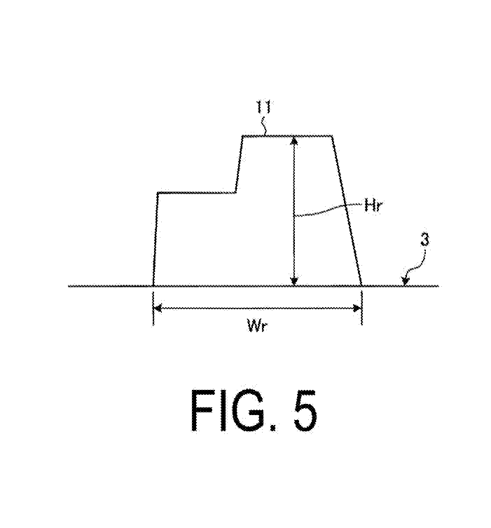

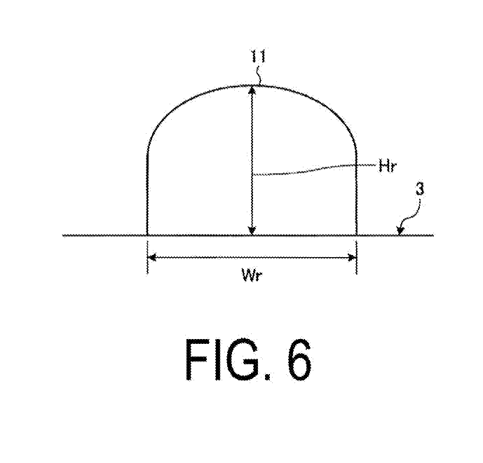

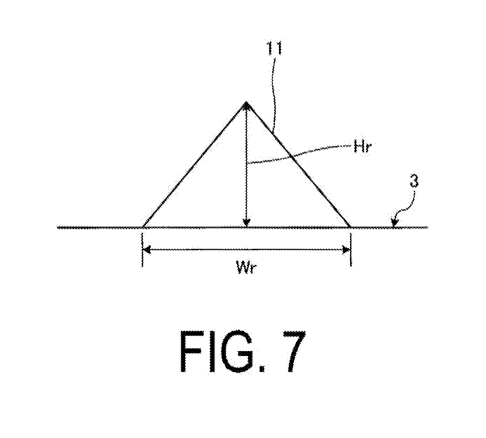

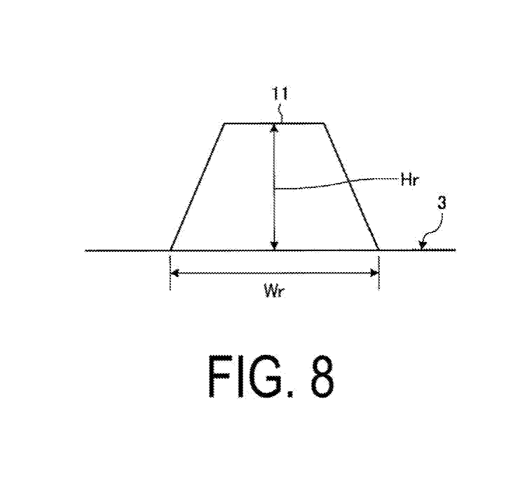

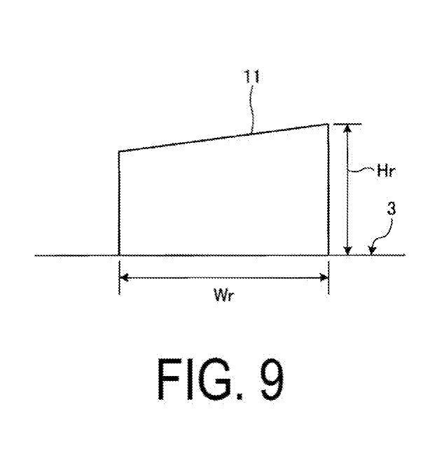

The height Hr of the stopper portion 11 projecting from the surface of the tread portion 2 is the dimension of a normal line of the imaginary profile F of the shoulder portion 3 between the tread portion 2 and the sidewall portion 4 with the greatest dimension to a projecting end of the stopper portion 11. Note that FIGS. 5 to 9 are meridian cross-section enlarged views of stopper portions. As illustrated in FIG. 5, the stopper portion 11 may include projecting ends having different heights with a step between. As illustrated in FIG. 6, the projecting end of the stopper portion 11 may have a shape that bulges in an arc-like manner. As illustrated in FIG. 7, the stopper portion 11 may have a triangular cross-section. As illustrated in FIG. 8, the stopper portion 11 may have a trapezoidal cross-section. As illustrated in FIG. 9, the stopper portion 11 may have a height that progressively varies. The meridian cross-section shapes of the stopper portions 11 illustrated in FIGS. 5 to 9 are examples and are not limited thereto.

When the projection height Hr of the stopper portion 11 is less than 0.5 mm, the projection portion 10 which deforms inward in the tire lateral direction almost comes into contact with the surface of the tread portion 2. As a result, the effect of ensuring a vehicle exterior noise reduction effect and hydroplaning resistance performance is likely to decrease. Note that when the projection height Hr of the stopper portion 11 is greater than 10 mm, great improvements cannot be expected in the effect of preventing the projection portion 10 which deforms inward in the tire lateral direction from collapsing. Accordingly, to significantly obtain the effect of ensuring a vehicle exterior noise reduction effect and hydroplaning resistance performance, the projection height Hr of the stopper portion 11 preferably ranges from 0.5 mm to 10 mm.

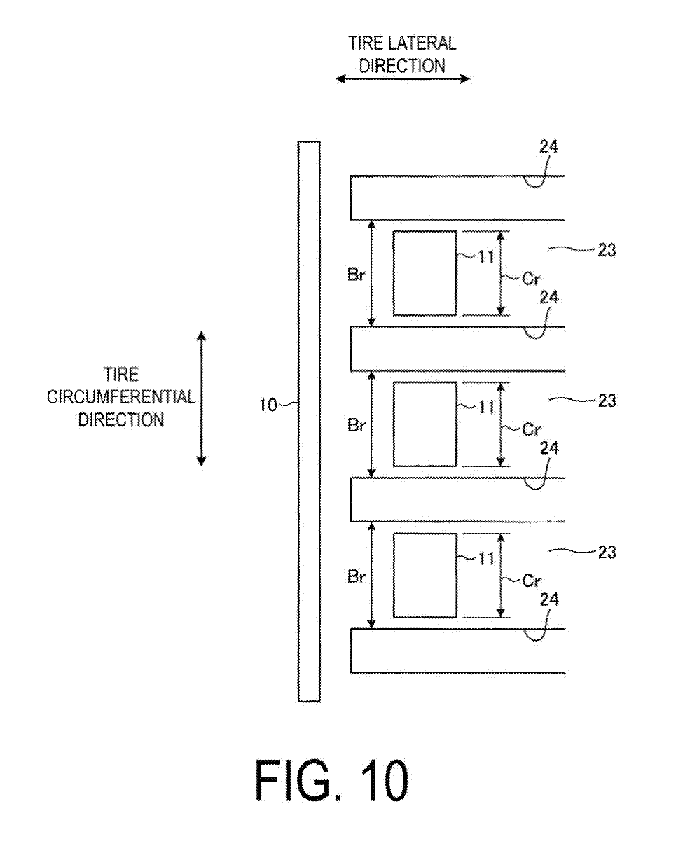

FIGS. 10 to 13 are plan views of projection portions and stopper portions. As illustrated in FIGS. 10 to 13, in the pneumatic tire 1 of the present embodiment, the stopper portions 11 preferably have a total dimension ΣCr of dimensions Cr in the tire circumferential direction that is 10% or greater of a total dimension ΣBr in the tire circumferential direction of dimensions Br between lug grooves 24 on the surface of the tread portion 2.

The dimension Br between the lug grooves 24 on the surface of the tread portion 2 is the maximum dimension in the tire circumferential direction, in the range in the tire lateral direction where the stopper portions 11 are provided in a band-like manner to be continuous in the tire circumferential direction. The dimension Cr of the stopper portion 11 in the tire circumferential direction is the maximum dimension of the stopper portion 11 in the tire circumferential direction.

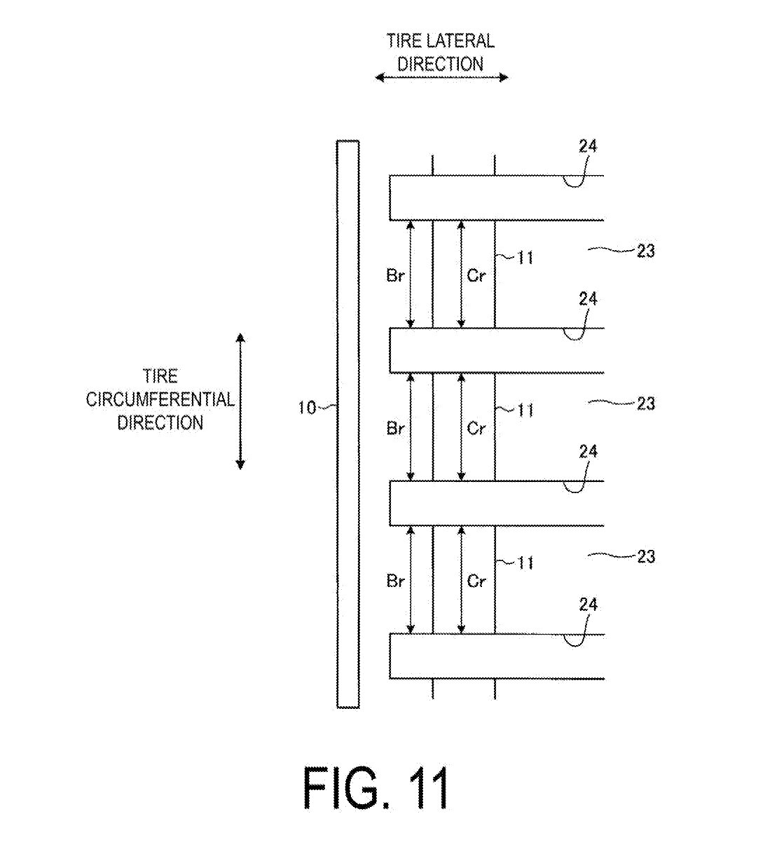

When the total dimension ΣCr of the stopper portions 11 in the tire circumferential direction is less than 10% of the total dimension ΣBr between the lug grooves 24 in the tire circumferential direction, the projection portion 10 which deforms inward in the tire lateral direction becomes difficult to support via the stopper portion 11. As a result, the effect of ensuring a vehicle exterior noise reduction effect and hydroplaning resistance performance is likely to decrease. As illustrated in FIG. 11, even in a case where the total dimension ΣCr of the stopper portions 11 in the tire circumferential direction is 100% of the total dimension ΣBr between the lug grooves 24 in the tire circumferential direction, the effect of ensuring a vehicle exterior noise reduction effect and hydroplaning resistance performance can be obtained. Accordingly, to significantly obtain the effect of ensuring a vehicle exterior noise reduction effect and hydroplaning resistance performance, the total dimension ΣCr of the stopper portions 11 in the tire circumferential direction is preferably from 10% to 100% of the total dimension ΣBr between the lug grooves 24 in the tire circumferential direction.

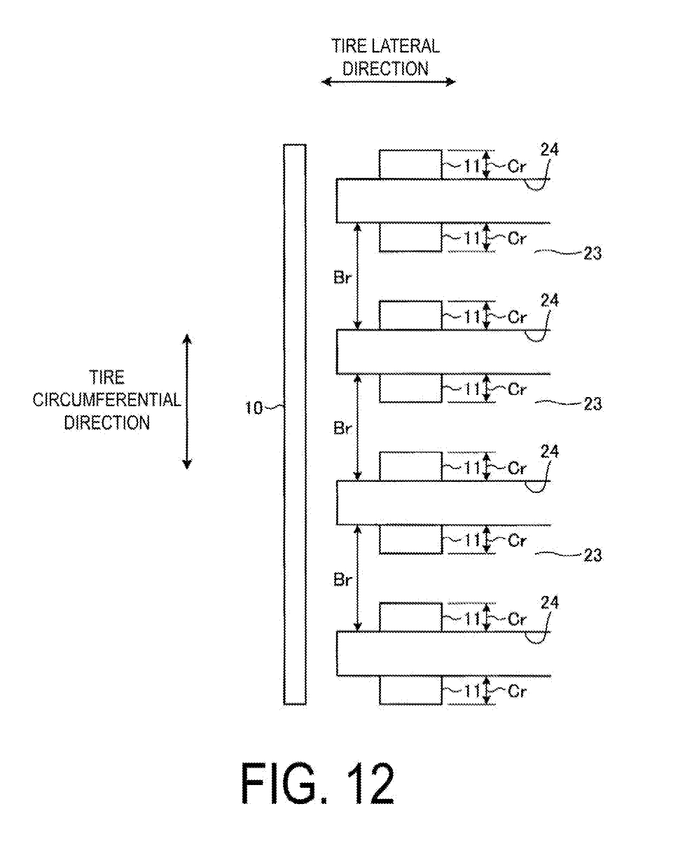

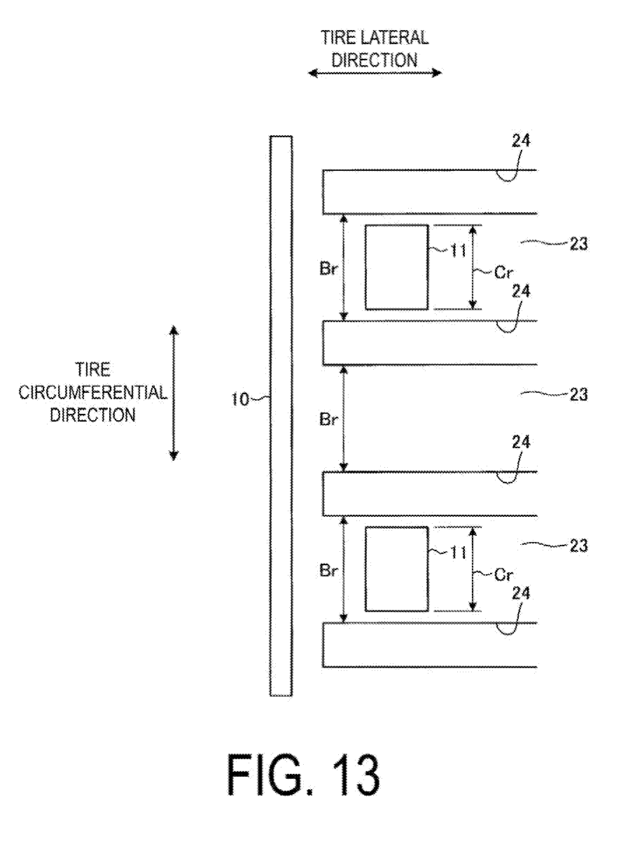

Note that when the total dimension ΣCr of the stopper portions 11 in the tire circumferential direction is 10% or greater than the total dimension ΣBr between the lug grooves 24 in the tire circumferential direction, as illustrated in FIG. 12, the stopper portion 11 can be preferably partially formed along both edges of the lug groove 24 in the tire circumferential direction to effectively keep the outer opening portion of the lug groove 24 in the tire lateral direction unblocked and suppress tire weight. Additionally, when the total dimension ΣCr of the stopper portions 11 in the tire circumferential direction is 10% or greater than the total dimension ΣBr between the lug grooves 24 in the tire circumferential direction, as illustrated in FIG. 13, the stopper portion 11 may preferably not be provided between all of the lug grooves 24 to suppress tire weight. In this example, the stopper portion 11 is preferably provided between the lug grooves 24 in every second or more instance to ensure uniformity in the tire circumferential direction.

As illustrated in FIGS. 1 and 2, in the pneumatic tire 1 of the present embodiment, in a meridian cross-section, a distance D in the tire radial direction between the road contact surface S of the tread portion 2 and the end 10a of the projection portion 10 is preferably 0.5 mm or greater when the tire is mounted on a regular rim, inflated to the regular internal pressure, and loaded with 70% of the regular load.

For the distance D in the tire radial direction between the road contact surface S of the tread portion 2 and the end 10a being less than 0.5 mm, when the pneumatic tire 1 deforms when the vehicle travels, the frequency of the projection portion 10 coming into contact with the road surface and the like is likely to increase, increasing instances of the projection portion 10 deforming. Accordingly, by the distance D in the tire radial direction between the road contact surface S of the tread portion 2 and the end 10a being 0.5 mm to greater, the instances of the projection portion 10 deforming are reduced. This allows a vehicle exterior noise reduction effect to be ensured.

As illustrated in FIGS. 3 and 4, in the pneumatic tire 1 of the present embodiment, the projection portion 10 has an angle θ formed by a center straight line SL and a tire radial direction line L in a meridian cross-section preferably ranging from 15° inward in the tire lateral direction to 45° outward in the tire lateral direction when the tire is mounted on a regular rim, inflated to the regular internal pressure, and loaded with 70% of the regular load.

Note that in a meridian cross-section, the center straight line SL is a straight line that joins a center point Pa of the thickness of the end 10a of the projection portion 10 and a center point Pb of the thickness (imaginary profile F) of the base end 10b, and run in the projecting direction of the projection portion 10.

The angle θ ranges from −15° to +45°, where the angle θ of the tire radial direction line L is taken as 0° and tilt inward in the tire lateral direction is taken as minus and tilt outward in the tire lateral direction is taken as plus.

When the angle θ formed by the center straight line SL and the tire radial direction line L is less than −15° (larger minus angle), the projection portion 10 is disposed close to the lug groove 24, making a noise shielding effect difficult to obtain. When the angle θ formed by the center straight line SL and the tire radial direction line L is greater than +45° (larger plus angle), the projection portion 10 is susceptible to coming into contact with the tire itself, which may cause wear and chipping in the portion where contact occurs. Accordingly, by the angle θ formed by the center straight line SL and the tire radial direction line L ranging from −15° to +45°, a noise shielding effect from the projection portion 10 can be significantly obtained. Note that to more significantly obtain a noise shielding effect from the projection portion 10, the angle θ formed by the center straight line SL and the tire radial direction line L preferably ranges from −5° to +30°.

Furthermore, the pneumatic tire 1 of the present embodiment preferably has a designated vehicle inner/outer orientation when mounted on a vehicle, and the projection portion 10 is preferably formed at least on the vehicle outer side.

The designated vehicle inner/outer side orientation when the tire is mounted on a vehicle, while not illustrated in the drawings, for example, can be shown via indicators provided on the sidewall portion 4. The side facing the inner side of the vehicle when the tire is mounted on the vehicle is the “vehicle inner side”, and the side facing the outer side of the vehicle is the “vehicle outer side”. Note that the designations of the vehicle inner side and the vehicle outer side are not limited to cases where the tire is mounted on a vehicle. For example, in cases when the tire is mounted on a rim, orientation of the rim with respect to the inner side and the outer side of the vehicle in the tire lateral direction is predetermined. Thus, in cases in which the pneumatic tire 1 is mounted on a rim, the orientation with respect to the vehicle inner side and the vehicle outer side in the tire lateral direction is designated.

According to the pneumatic tire 1, vehicle external noise is released on the vehicle outer side. Thus, by forming the projection portion 10 on at least the vehicle outer side, noise shielding can be effectively provided, and vehicle external noise can be reduced.

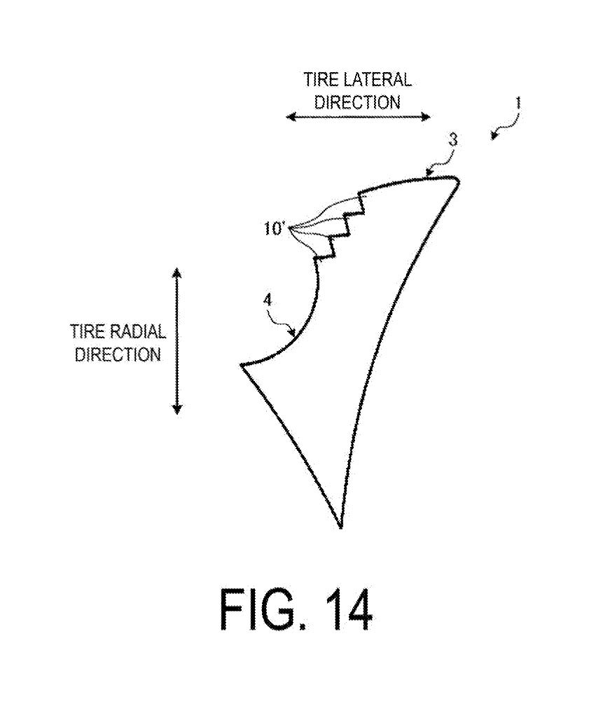

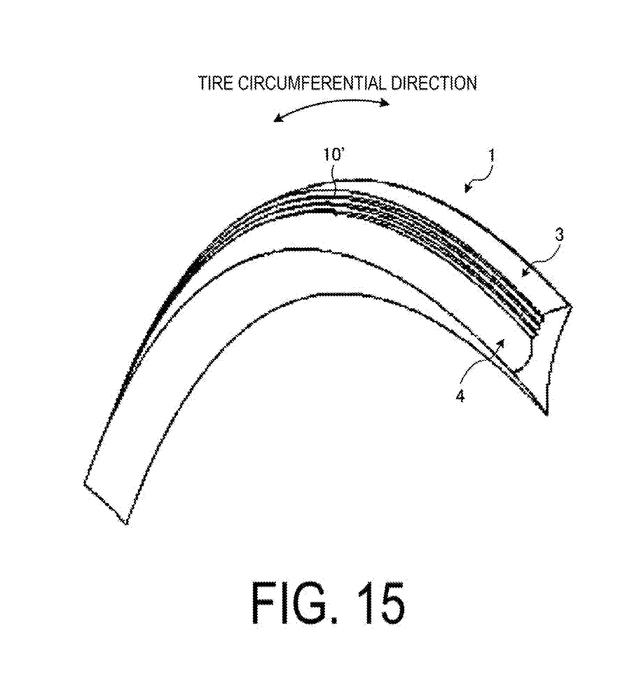

FIG. 14 is an enlarged cross-sectional view of a main portion of another example of the pneumatic tire according to the present embodiment. FIG. 15 is a partial perspective view of the example of the pneumatic tire illustrated in FIG. 14.

As illustrated in FIGS. 14 and 15, another example of the pneumatic tire 1 according to the present embodiment includes a projection portion 10′ instead of the projection portion 10 described above. The projection portion 10′ is provided continuously in the tire circumferential direction and is disposed outward in the tire lateral direction of the opening portion of the outermost lug groove 24 in the tire lateral direction provided on the tread portion 2. The projection portion 10′ is formed projecting outward in the tire radial direction. Additionally, a plurality (four in the present embodiment) of the projection portions 10′ are formed in the tire radial direction. In FIGS. 14 and 15, the projection portions 10′ have a triangular shape in a meridian cross-section with a V-shaped groove provided therebetween.

### EXAMPLES

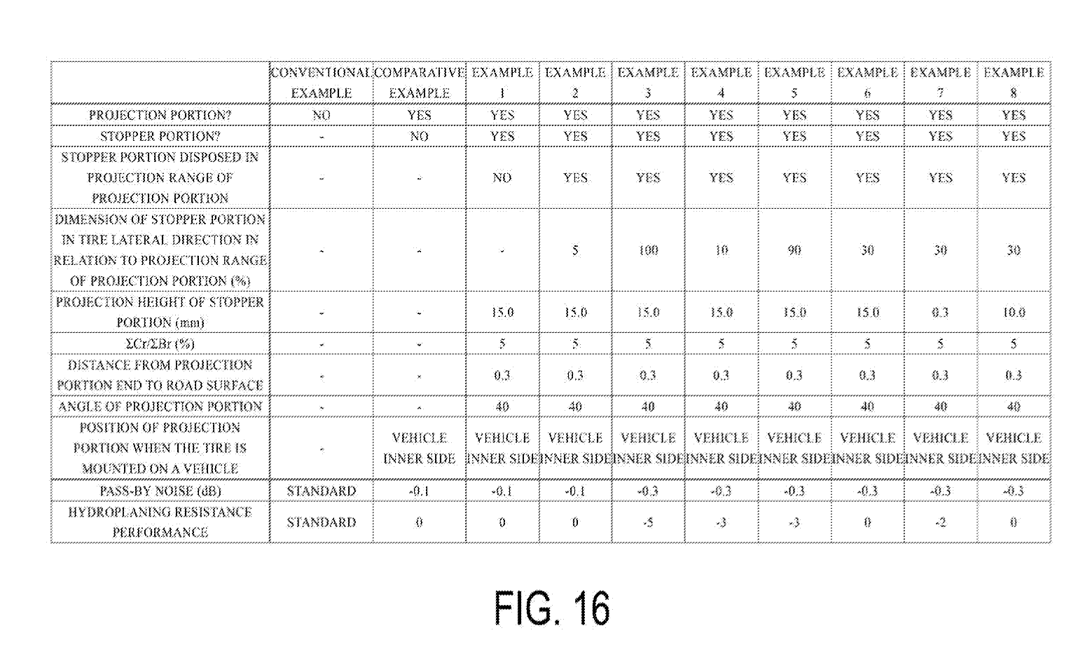

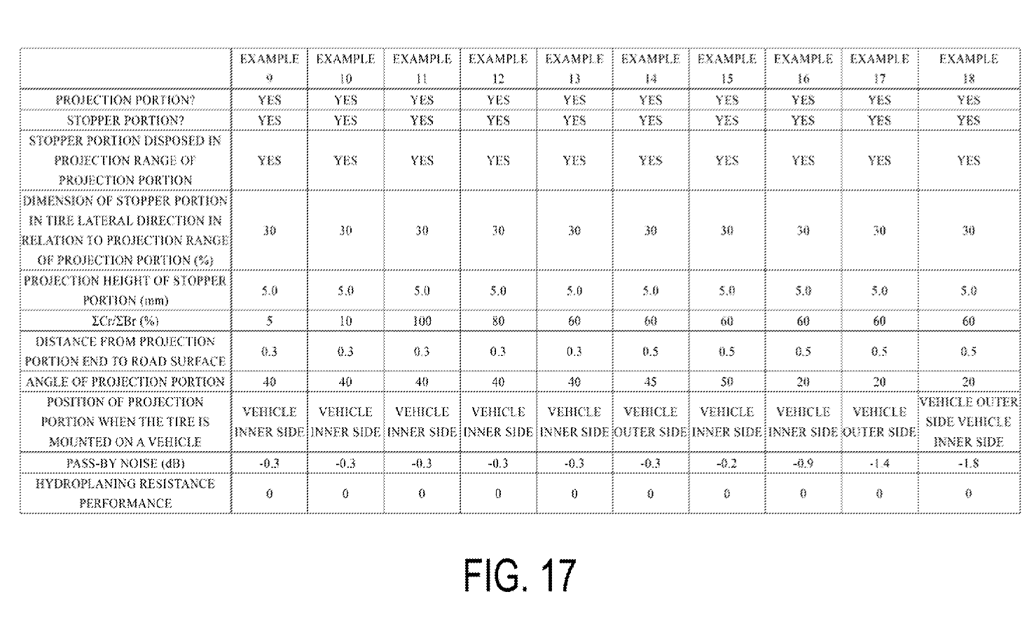

In the examples, performance tests for pass-by noise and hydroplaning resistance performance were performed on a plurality of types of pneumatic tires of different conditions (see FIGS. 16 and 17).

In the performance tests, pneumatic tires (test tires) having a tire size of 245/40R18 93W were mounted on regular rims (18×8 1/2J) and inflated to the regular internal pressure (250 kPa). Then, the pneumatic tires were mounted on a sedan type test vehicle having an engine displacement of 3000 cc.

In the evaluation method of pass-by noise, the magnitude of vehicle external pass-by noise was measured according to the tire noise test method specified in ECE Regulation No. 117 Revision 2 (ECE R117-02). In the test, the test vehicle was driven in a section prior to a noise measurement section, and before the noise measurement section, the engine was stopped and the test vehicle was allowed to coast in the noise measurement section where the maximum noise level dB (noise level in the frequency range of 800 Hz to 1200 Hz) was measured. This was repeated a plurality of times at a plurality of speeds, the speeds being eight or more substantially evenly divided within the range of ±10 km/h of the standard speed, and the average vehicle external pass-by noise was taken. The maximum noise level dB is the sound pressure dB (A) measured through an A characteristic frequency correction circuit using a microphone installed 7.5 m to the side of a travel center line and 1.2 m up from the road surface at a middle point in the noise measurement section. The measurement results are expressed as index values and evaluated with the conventional example being assigned as the reference (0). In the evaluation, values for the sound pressure dB less than the reference indicate low pass-by noise and superior vehicle external noise reduction performance.

In the evaluation method of hydroplaning resistance performance, the test vehicle was repeatedly driven into a 10-mm deep pool of water while travelling straight, with the speed of entrance being increased until hydroplaning occurred. The entrance speed at which hydroplaning occurred was measured. The measurement results are expressed as index values and evaluated with the conventional example being assigned as the reference (0). In the evaluation, points corresponding to entrance speed less than the reference indicate superior hydroplaning resistance performance.

The pneumatic tire of the conventional example illustrated in FIG. 16 includes no projection portions. The pneumatic tire of the comparative example includes a projection portion with the shape illustrated in FIG. 3 but no stopper portions. As indicated in FIGS. 16 and 17, the pneumatic tires of Examples 1 to 18 are provided with a projection portion with the shape illustrated in FIG. 3 and a stopper portion. Note that the angle of the projection portion is minus when tilted inward in the tire lateral direction and plus when tilted outward in the tire lateral direction.

As can be seen from the test results of FIGS. 16 and 17, the pneumatic tires of Examples 1 to 18 have low pass-by noise and enhanced vehicle external noise reduction performance. Additionally, the pneumatic tires of Examples 1 to 18 have enhanced hydroplaning resistance performance.

1. A pneumatic tire, comprising:
a lug groove disposed outermost in a tire lateral direction in a tread portion, the lug groove opening outward in the tire lateral direction;
a projection portion disposed outward of an opening portion of the lug groove in the tire lateral direction, the projection portion extending outward in a tire radial direction past a groove bottom of the lug groove at maximum groove depth in a meridian cross-section and comprising an end disposed inward of a road contact surface of the tread portion in the tire radial direction, when the pneumatic tire is mounted on a regular rim, inflated to a regular internal pressure, and loaded with 70% of a regular load; and
a stopper portion projecting from a surface of the tread portion at a position outward of a ground contact edge in the tire lateral direction and inward of the projection portion in the tire lateral direction.

2. The pneumatic tire according to claim 1, wherein the stopper portion is at least partially disposed in a range where the projection portion is projected inward in the tire lateral direction on the surface of the tread portion.

3. The pneumatic tire according to claim 1, wherein the stopper portion has a dimension in the tire lateral direction ranging from 10% to 90% of a range in the tire lateral direction where the projection portion is projected inward in the tire lateral direction on the surface of the tread portion.

4. The pneumatic tire according to claim 1, wherein the stopper portion has a height projecting from the surface of the tread portion of 0.5 mm or greater.

5. The pneumatic tire according to claim 1, wherein the stopper portion has a total dimension in a tire circumferential direction of from 10% to 100% of a total dimension in the tire circumferential direction between the lug grooves in the surface of the tread portion.

6. The pneumatic tire according to claim 1, wherein the projection portion has a distance in the tire radial direction from the road contact surface of the tread portion to the end of 0.5 mm or greater, when the pneumatic tire is mounted on a regular rim, inflated to a regular internal pressure, and loaded with 70% of a regular load.

7. The pneumatic tire according to claim 1, wherein the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

8. The pneumatic tire according to claim 1, wherein a vehicle inner/outer side orientation when the pneumatic tire is mounted on a vehicle is designated, and the projection portion is at least formed on a vehicle outer side.

9. The pneumatic tire according to claim 2, wherein the stopper portion has a dimension in the tire lateral direction ranging from 10% to 90% of a range in the tire lateral direction where the projection portion is projected inward in the tire lateral direction on the surface of the tread portion.

10. The pneumatic tire according to claim 9, wherein the stopper portion has a height projecting from the surface of the tread portion of 0.5 mm or greater.

11. The pneumatic tire according to claim 10, wherein the stopper portion has a total dimension in a tire circumferential direction of from 10% to 100% of a total dimension in the tire circumferential direction between the lug grooves in the surface of the tread portion.

12. The pneumatic tire according to claim 11, wherein the projection portion has a distance in the tire radial direction from the road contact surface of the tread portion to the end of 0.5 mm or greater, when the pneumatic tire is mounted on a regular rim, inflated to a regular internal pressure, and loaded with 70% of a regular load.

13. The pneumatic tire according to claim 12, wherein the projection portion has an angle formed by a center straight line and a tire radial direction line in a meridian cross-section ranging from 15° inward in the tire lateral direction to 45° outward in the tire lateral direction, when the pneumatic tire is mounted on a regular rim, inflated to a regular internal pressure, and loaded with 70% of a regular load.

14. The pneumatic tire according to claim 13, wherein a vehicle inner/outer side orientation when the pneumatic tire is mounted on a vehicle is designated, and the projection portion is at least formed on a vehicle outer side.
